(19) United States
(12) Patent Application Publication
(10) Pub. No.: US 2021/0392003 A1
(43) Pub. Date: Dec. 16, 2021

(54) DECENTRALIZED COMPUTING SYSTEMS AND METHODS FOR PERFORMING ACTIONS USING STORED PRIVATE DATA

(71) Applicant: LOGIN ID INC., SAN MATEO, CA (US)

(72) Inventors: SIMON LAW, SAN MATEO, CA (US); ALFRED JOHN MENEZES, WATERLOO, ON (CA); PASAN CHANKAMA HAPUARACHCHI, SAN ANSELMO, CA (US)

(21) Appl. No.: 17/345,733

(22) Filed: Jun. 11, 2021

Related U.S. Application Data
(60) Provisional application No. 63/038,534, filed on Jun. 12, 2020.

(51) Int. Cl. H04L 9/32; H04L 9/06; H04L 9/08

(52) U.S. Cl. CPC H04L 9/3271; H04L 9/3247; H04L 2209/38; H04L 9/0656; H04L 9/0825; H04L 9/3231

(57) ABSTRACT

It is typically difficult for a user to have any awareness of which private data is being used by a third party and to control the flow of the private data to the third party. A computing system is provided with a trusted node that stores encrypted private data. When the third party wishes to obtain information types from the user, the trusted node generates a scope document that specifies the requested information types. This scope document is sent to the user device as a challenge. The user device uses the scope document to display the requested information types, and the user provides input to permit providing the information types to the third party. The user device returns a signed challenge response, which includes the scope document. The trusted node then decrypts the encrypted private data, which corresponds to the requested information types, for the third party.

### CROSS-REFERENCE TO RELATED APPLICATION(S)

This patent application claims priority to U.S. Provisional Patent Application No. 63/038,534, filed on Jun. 12, 2020, and titled “DECENTRALIZED COMPUTING SYSTEMS AND METHODS FOR PERFORMING ACTIONS USING STORED PRIVATE DATA”, the entire contents of which are herein incorporated by reference.

### TECHNICAL FIELD

The following generally relates to decentralized computing systems and methods for performing actions using stored private data. The decentralized computing systems includes a blockchain network of nodes.

### DESCRIPTION OF THE RELATED ART

People interact with computing platforms over the Internet to perform actions that use private data, including and not limited to personal identifiable information. There are other types of data that people or even computing systems wish to keep private, and for which they desire another party's computing system to use to perform some action. For example, through a web browser on a user device, private data is transmitted to the other party's computing system so that the other party's computing system can use the private data to perform an action as desired by the user.

People or their user devices, or both, can repeatedly provide the private data to the other party's computing system each time the action is desired to be taken. However, it is herein recognized that this is a time-consuming process for the user and the other party, and also makes the private data more vulnerable to theft by an adversary.

It is also herein recognized that it is typically difficult for the user to have any awareness of which specific private data is being used by a third party. It is even more rare and difficult to control the flow of the specific private data to the third party.

Private data can also be stored by the other party's computing system and then locally retrieved each time the action is desired to be taken. However, it is herein recognized that this is a large burden of responsibility to the other party's computing system to securely store private data. If a data breach occurs at the other party's computing system, then the private data can be obtained by an adversary.

Private data can be stored on a blockchain, which in many cases supports an immutable ledger of data. While the data can be encrypted, it is herein recognized that there is a desire to delete data so that other parties on the blockchain network (e.g. such as a public blockchain network) cannot access or recreate the private data. However, deleting the private data is technically difficult given the immutable nature of blockchains.

It is therefore herein recognized that storing private data in a secure manner, later securely and automatically retrieving this private data for use by the other party's computing system, and later deleting the private data from the computing systems, are technically difficult.

### BRIEF DESCRIPTION OF THE DRAWINGS

Embodiments will now be described by way of example only with reference to the appended drawings wherein:

FIG. 1 is a schematic diagram of an example of user devices, trusted nodes, relying party systems and a blockchain network of nodes in communication with each other over a data network.

FIGS. 2, 3A, 3B, 4 and 5 are schematic diagrams showing different example embodiments of the computing systems, including a secure execution and secure storage environment.

FIG. 6 is a flow diagram of computer executable or processor implemented instructions for generating distributed keys, according an example embodiment.

FIG. 7 is a flow diagram of computer executable or processor implemented instructions for generating multiple sets of distributed keys, according to another example embodiment.

FIG. 8 is a flow diagram of computer executable or processor implemented instructions for encrypting private data, according to an example embodiment.

FIG. 9A is a flow diagram of computer executable or processor implemented instructions for decrypting private data using a scope document, according to an example embodiment.

FIG. 9B is a flow diagram of computer executable or processor implemented instructions for decrypting private data using a scope document, according to an example embodiment that is in alternative to the embodiment in FIG. 9A.

FIG. 9C is a flow diagram of computer executable or processor implemented instructions for decrypting private data using a scope document, according to an example embodiment that is in alternative to the embodiment in FIG. 9A.

FIG. 10 is a flow diagram of computer executable or processor implemented instructions for deleting the subject data from the computing system.

FIG. 11 is a flow diagram of computer executable or processor implemented instructions for reading and subsequently deleting the subject data from the computing system.

FIG. 12 is a flow diagram of computer executable or processor implemented instructions for reading and deleting the subject data from the computing system, as well as adding new subject data to the computing system.

FIG. 13 is a flow diagram of computer executable or processor implemented instructions for encrypting private data using a native application, according to an example embodiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It an example aspect, an improved login or data access system is provided that satisfies related regulatory standards. For instance, some regulations requires organizations and companies to provide consumers certain rights that relates to their private information, including specifically the right to be forgotten. Private Identifiable information (PII) will need to be deleted from the data network system. It is herein recognized that deleting data from a blockchain network, which in many embodiments is decentralized and has an immutable ledger, is technically challenging. The improved login or data access system herein facilitates usage of the blockchain network, while still being able to delete the private data at a later time as desired.

It is also herein recognized that users often do not know what data about themselves is being sent to third parties. In an example aspect, a login or data access system is described herein that includes a trusted node that interacts with a third party (e.g. a relying party system) and a user device. The system uses a scope document to bring awareness to the user about the data being required by the relying party system, and to provide a permissions and authorization mechanism using strong authentication. In particular, user data is securely encrypted and stored using a trusted node and a blockchain network of nodes. Examples of subject data that are stored include: a user's name, a user's address, a user's citizenship, a user's date of birth, a user's age, a user's travel itinerary, a user's location information, a user's driver license number, a user's photograph used in a driver's license, a user's photograph used in a passport, a user's photograph used in a health card, a user's medical data, a user's social insurance number, and a user's banking information. The subject data can be stored and organized as subject data parcels. In an example aspect, the trusted node stores derivative and encrypted values based on the one or more subject data parcels, and the corresponding one or more ciphers are stored on the blockchain network of nodes. The relying party system wants to obtain certain information from the user to complete an action (e.g. log the user in, provide data access to the user, complete a transaction, execute a registration, execute an authorization, execute a security pass for the user, physically conduct an action using machines, etc.). For example, the relying party system wants to obtain the name and address of a user. It will be appreciated that the relying party system could also request to obtain any other subset of the subject data parcels that are securely stored. The trusted node creates a scope document based on this requested information types of the one or more subject data parcels. The scope document is a data file that identifies the specific types of information being requested by the relying party system. For example, if the requested information is name and address, then the scope document includes the name and address. Importantly, the scope document forms part of a challenge that is sent to the user device. The user device presents the requested information in a graphical user interface (GUI) to the user, and the user inputs confirmation via the GUI that the requested information can be provided to the relying party system. The confirmation is signed using a strong authentication process that includes, for example, a biometric scanning of the user. In other words, the signed challenge response includes the scope document. This keeps a record to show that the user has authorized specific information, which are the requested subject data parcels, to be obtained by the relying party system. Furthermore, this also allows the user to see and control the types of data being obtained by the relying party system. If the user does not want to provide the requested subject data to the relying party, the user inputs a denial response into the GUI and the session between the relying party system and the trusted node to obtain the requested data becomes terminated.

In another example aspect, using the GUI, the user can select which specific types of information can be provided to the relying party system, and which other specific types are not permitted to be provided to the relying party system. For example, the relying party system requests name, address, date of birth, age, sex, and marital status, and these types of information are specified in a scope document. The GUI uses the scope document to present this requested information types to the user, and the user uses the GUI to selective confirm that only the name and age are permitted to be provided to the relying party system, but not the other requested data. In other words, in an example embodiment, the scope document requests a set of X number of different information types, but the permitted information types that have been confirmed by the user is a subset Y, where Y is a subset of X. This confirmation of the subset Y information types is reflected in the scope document, which is sent back to the trusted node in a signed challenge response.

In another example aspect, the login network is simple and easy for users to use, and is a system that is massively scalable. By contrast, common existing approaches that requires the user to download software, use, special browsers, or install plugins are filled with friction and create significant drop-off in usage by customers. To that end, in another example aspect of the login network, the user is not required to manually download and install any special software, while at the same time, the improved login system provides the users with the benefits achievable by the blockchain when compared to a centralized solution.

In an example aspect, the login network is a more secure, frictionless, and decentralized computer platform than what currently exists today for both blockchain applications (smart contracts) and traditional web applications.

In another example aspect, the login network is a trusted source for identity, while also providing capabilities to maintain privacy.

Below are example aspects of the login network, which will be discussed in greater detail in this document.

In an example aspect of the system, a distributed computing architecture is herein described that can provide authentication and privacy without dependencies on centralized trust anchors. Additionally, for those users seeking a frictionless experience that do not desire to install any additional software, the login network architecture diffuses the private data amongst multiple nodes and encrypts the data with a threshold encryption scheme will also be described.

In an example aspect of the system, privacy is provided. The data subject is able to assert their privacy rights regarding their data, while still enjoying the benefits of using a blockchain when compared to a centralized solution.

In an example aspect, user control of the which information types of data being transmitted is provided.

In an example aspect of the system, regulatory compliance is provided. The system enables using a decentralized architecture, while at the same time adhering to regulatory standards designed to protect people's data.

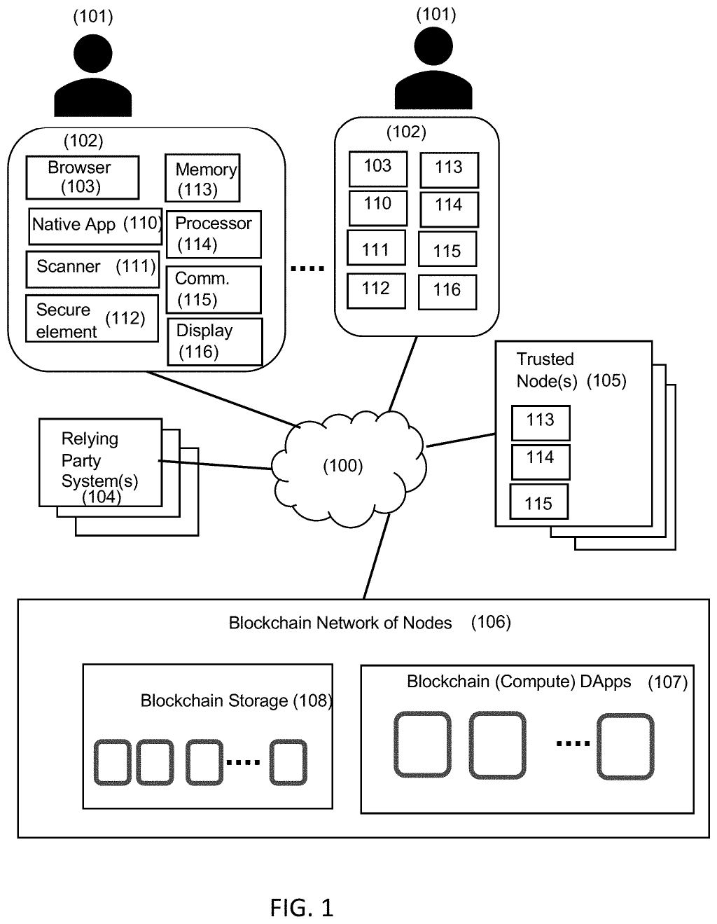

Turning to FIG. 1, the computing architecture includes one or more users 101 and their user devices 102, having web browsers 103 for accessing websites of relying party systems 104. Examples of a relying party system are servers that belong to companies, merchants, organizations, government bodies, institutions, etc. In an example aspect, the user devices include one or more biometric scanner systems 111, such as, but not limited to, a fingerprint scanner, a camera system, and an infrared dot projector. These systems can be used for biometric authentication (e.g. thumbprint identification, facial identification, eyes identification, etc.). The user device also include a secure element 112. The secure element or secure enclave is a hardware module that securely stores data on the user device. For example, the secure element stores private data. In another example aspect, the secure element stores private keys. In another example aspect, the secure element stores data used in a Fast Identity Online (FIDO) authentication process, including biometric data and a FIDO private key associated with the user and their user device. The user device 102 also includes a memory 113, a processor 114, a communication module 115, and a display device 116.

In an example aspect, the user device 102 includes a native application 110, also herein called a native app. More generally, a user agent on the user device, which includes at least one of the native app and the browser, is used to interact with the user. In other words, the user agent can be a browser, or a native app, or both. The user agent, for example, is stored on the memory 113 of the user device.

Examples of a user device 102 include a mobile device, a smart phone, a laptop, a tablet, a smart hub (also sometimes called a home hub), a smart watch, a user device integrated into a car, and a desktop computer.

There are also one or more trusted nodes 105 and a blockchain network of nodes 106. It will be appreciated that these nodes, systems, and user devices are computing devices (e.g. including one or more of desktop computers, mobile devices, server machines, cloud computing servers, virtual machines on cloud computing servers, etc.). These computing devices or computing systems, or both, interact with each other via the data network 100. For example, the data network is the Internet. These computing devices or computing systems, or both, include a processor system, memory, and a communication system.

For example, each trusted node includes its own memory 113, processor 114 and communication module 115.

In another example embodiment, a company, merchant, organization, etc. that operates the relying party system alternatively (or in addition) has a native application or app 110 that resides on the user device 102, and the native app 110 has a trusted node SDK that facilitates the native app to communicate with a trusted node 105. In other words, the principles of securely storing and accessing private data can be used in a browser environment or in a native app environment, or both.

In an example embodiment, the blockchain network of nodes 106 includes blockchain compute nodes that execute distributed applications (DApps) 107 and blockchain storage nodes 108 that store data in a distributed ledger.

A non-limiting example embodiment of a blockchain network of nodes is the Ethereum network, in which there are multiple computing devices (e.g. nodes) that form the blockchain network. It is appreciated that there are other blockchain network of nodes that are applicable to the principles described herein.

In an example embodiment, the blockchain compute DApp nodes 107 are part of a first blockchain network, and the blockchain storage nodes 108 are part of a second blockchain network, which together form the network 106. In an example embodiment, the blockchains 107 and 108 are part of the same network.

In another example embodiment, the blockchain 107 is the Ethereum network and the blockchain 108 is the Interplanetary File System database. It will be appreciated that this is just an example and that other currently known networks and future-known networks can be used according to the principles described herein.

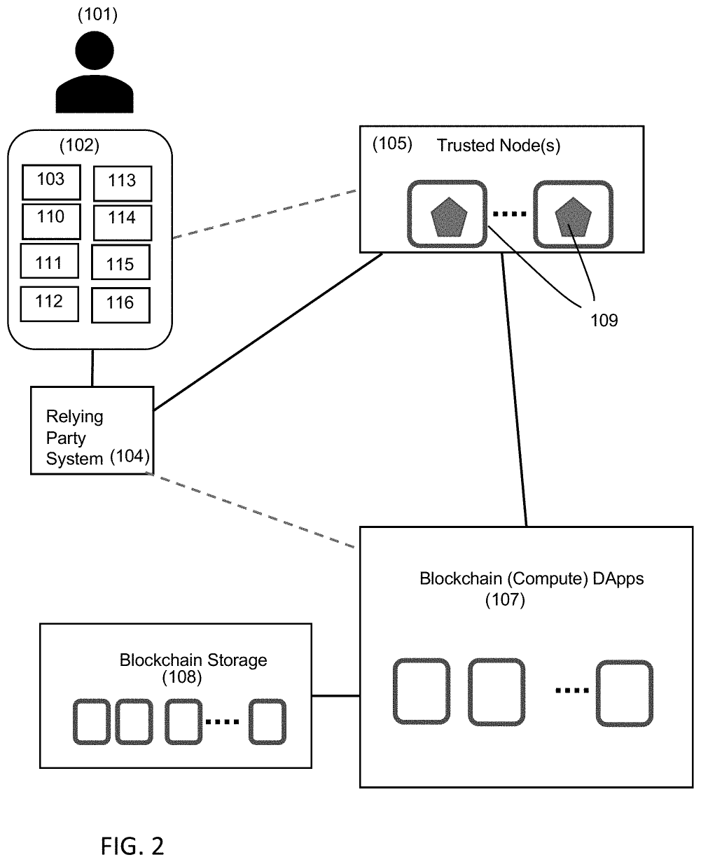

FIGS. 2, 3A, 3B, 4 and 5 show different example embodiments of the decentralized computing architecture, where a secure execution and secure storage environment 109 resides on different hardware environments. It will be appreciated that a secure execution and secure storage environment can be established using one or more of specific computing hardware and specific software. For example, a secure execution and secure storage environment can be established using one or more of: a Trusted Execution Environment (TEE); a firewall; a software layer; a secure enclave; a Hardware Secure Module (HSM); etc. It will be appreciated that a TEE is a computing chip that, for example, exists on a processor device. It will be appreciated that a HSM is a separated computing appliance.

FIGS. 2 to 5 show that the user device 102 interacting with a relying party system 104, and that the relying party system interacts with one or more trusted nodes 105. The one or more trusted nodes (herein called “trusted node” to refer to one or multiple ones of these nodes). The trusted node and the blockchain compute DApps 107 exchange data with each other. The blockchain compute DApps 107 coordinate storage and retrieval from the blockchain storage 108.

In some example embodiments, the user device 102 and the trusted node 105 communicate with each other. In some example embodiments, the relying party system 104 and the blockchain compute DApps 107 communicate with each other.

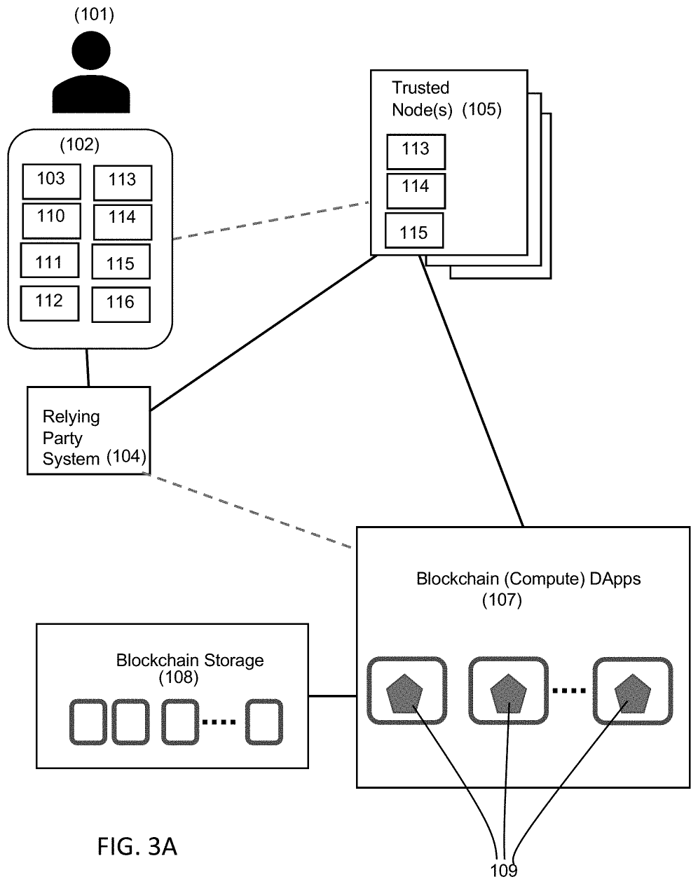

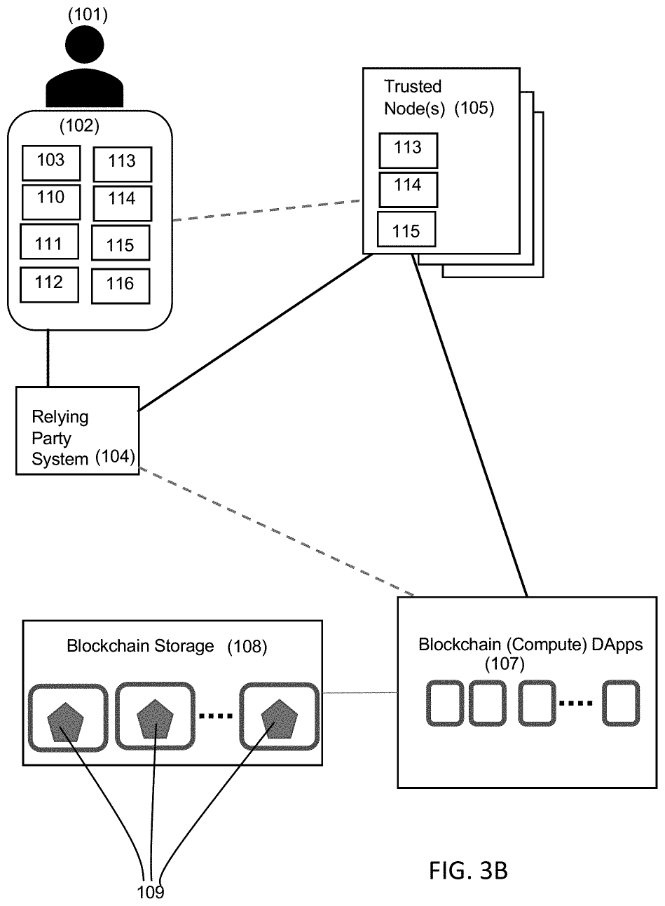

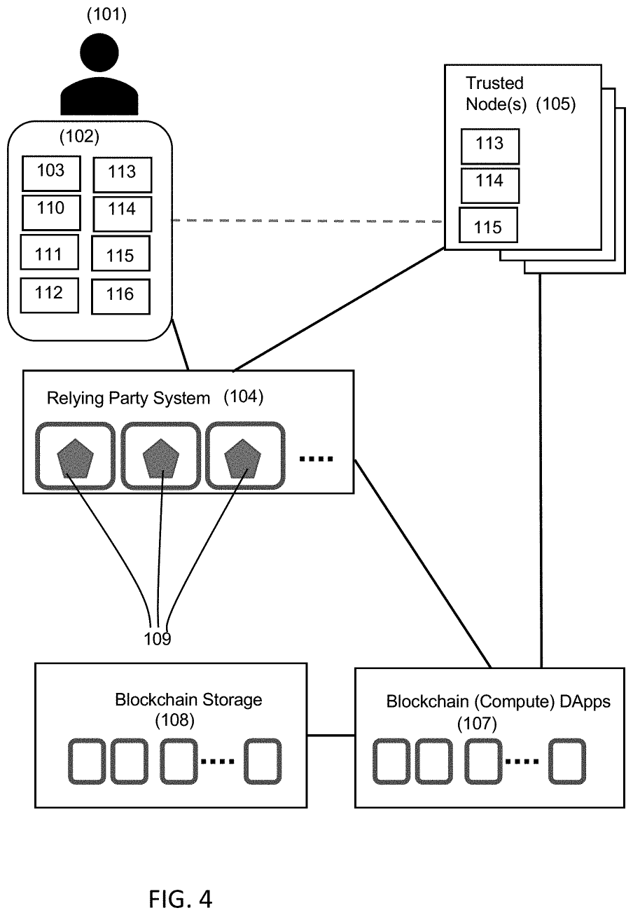

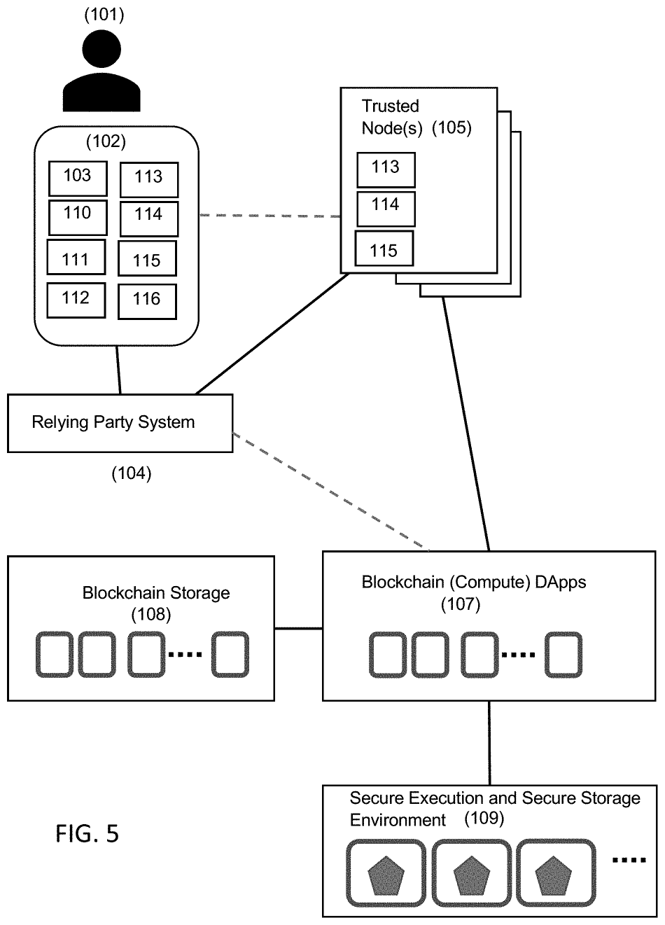

FIG. 2 shows that the secure execution and secure storage environment 109 resides on the one or more trusted nodes 105. FIG. 3A shows that the secure execution and secure storage environment 109 resides on the nodes in the blockchain compute DApps 107. FIG. 3B shows that the secure execution and secure storage environment 109 resides on the nodes of the blockchain storage 108. FIG. 4 shows that the secure execution and secure storage environment 109 resides on nodes of one or more relying party systems 104. FIG. 5 shows that the secure execution and secure storage environment 109 is separate and accessible by the blockchain compute DApps 107.

The computations for distributed key generation and the distributed private key storage, which are discussed in more detail below, take place in the secure execution and secure storage environment 109. It will be appreciated that these computations and storage can therefore reside on different computing devices. It will also be appreciated that the blockchain computing DApps direct the generation of the distributed keys to take place in the specified environment 109.

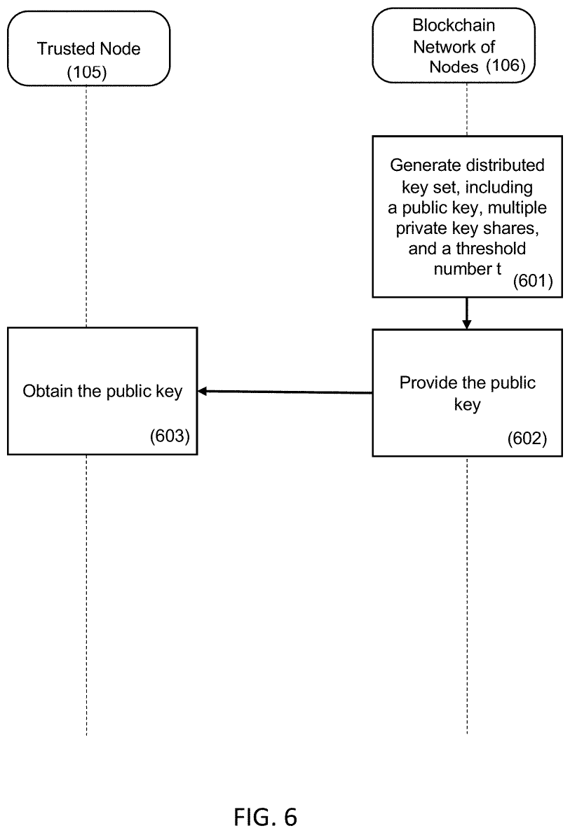

Turning to FIG. 6, at block 601, the blockchain network of nodes 106 generates distributed key set, including a public key, multiple private key shares, and a threshold number t. This computation takes place in a distributed manner across multiple computing devices, each in a secure execution and secure storage environment 109. The private keys shares are stored in the environment 109 of the respective computing devices.

In an example embodiment, a distributed key generation algorithm outputs a threshold public key PUB_th and multiple corresponding private key shares PRIV_th_{1 . . . N}. N is the number of private key shares that are outputted, where each private key share is respectively generated and stored on a different node or a different computing device. In other words, there are multiple private key shares that correspond to one public key. A threshold number t is also provided, where t≤N. In this way, it is possible that a smaller number of private keys shares (e.g. smaller than the total number N created) are required to execute a decryption. In an example aspect, the specific key shares, and the corresponding nodes on which the key shares are stored, that form the reconstruction group of key shares are not known at the time of the key generation and can be determined when decryption occurs.

For example, t is a smaller number than N, so that in case one or more nodes of the set N are unavailable, the decryption process can still take place so long as at least t nodes with the private key shares are available.

As will be described in further detail, as part of the decryption process, the t nodes will send a decryption share (e.g. a partial plaintext) to a combiner module, and the combiner module will in turn obtain the complete plaintext. For example, the relying party system 104 includes or is the combiner module.

The blockchain network of nodes 106 provides the public key to the trusted node 105. The trusted node 105 obtains the public key (blocks 602, 603).

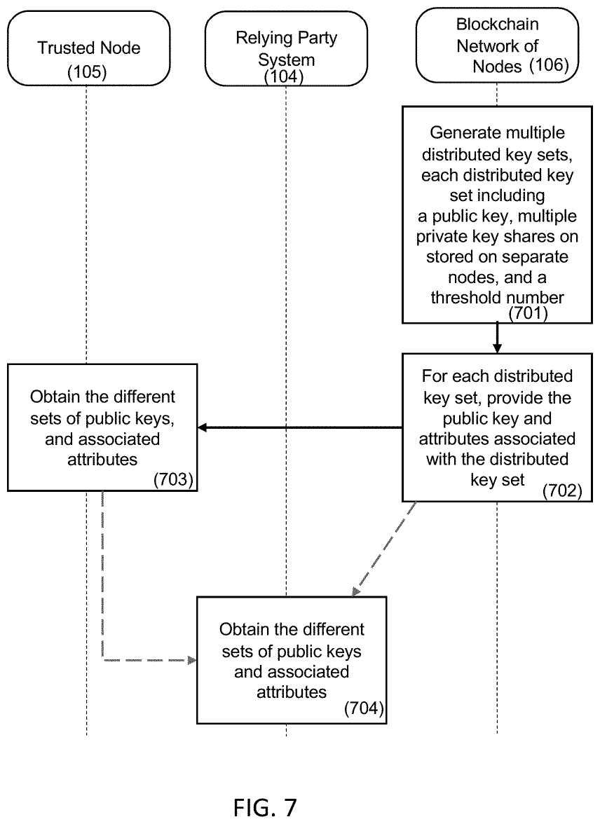

FIG. 7 shows an alternative embodiment to FIG. 6 for distributed key generation. In particular, the blockchain network of nodes 106 generates multiple distributed key sets (block 701). Each distributed key set includes a public key, multiple private key shares on stored on separate nodes, and a threshold number t. Each of these distributed key sets have attributes associated with them, and the values of these attributes can vary amongst the different sets. The attributes for example, include one or more of the following: the number of nodes and private key shares N; the number t; the cost of performing decryption operations with the given set of nodes; the security or reliability, or both, of the nodes that store the private key shares; a rating; etc.

At block 702, for each distributed key set, the blockchain network of nodes provides the public key and attributes associated with the given distributed key set to the trusted node and the relying party system.

At blocks 703, 704, this data is obtained by the trusted node and the relying party system.

In this way, the trusted node or the relying party system, or both, can use the attributes to determine which distributed key set, and accordingly which corresponding public key, should be used to encrypt the private data.

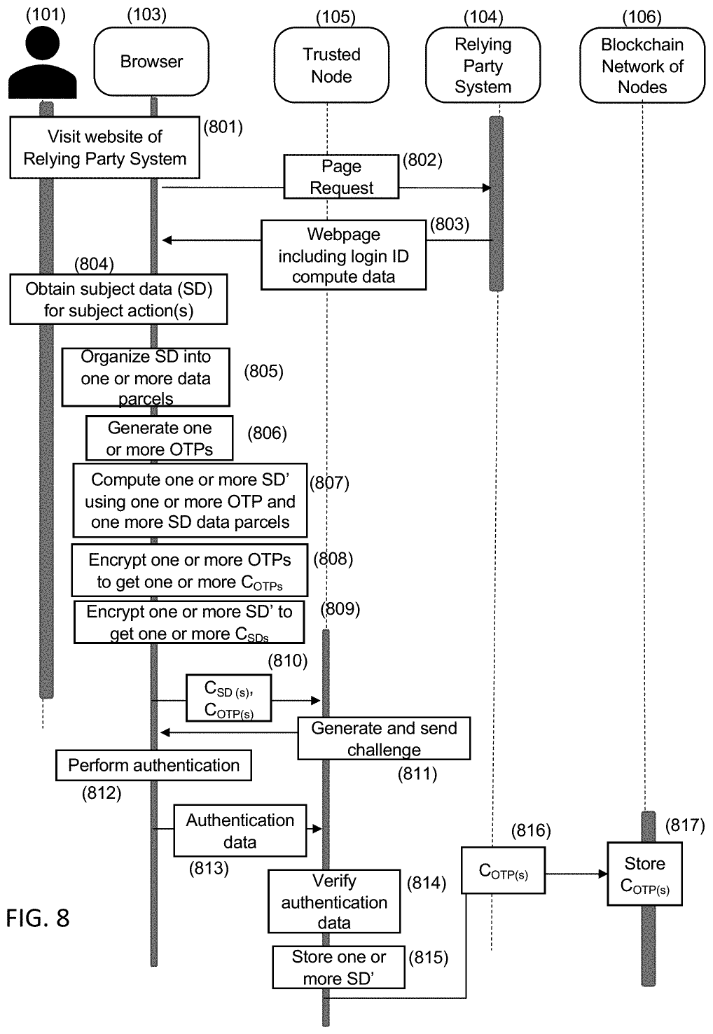

Turning to FIG. 8, after the distributed keys are generated, an encryption process of the private data takes place.

In particular, at block 801, the user 101 (via the browser 103) visits a website of the relying party system (block 801). The browser 801 of the user's device 102 sends a page request to the relying party system (block 802). The relying party system then provides a webpage to the browser, which includes login ID compute data (block 803).

In an example embodiment, this login ID compute data includes executable code for computing encryption of data that is to be locally run on the browser 103, as well as the threshold public key PUB_th. In an example embodiment, the executable code is Java Script.

In another example embodiment, this login ID compute data includes executable code that points to one or more trusted nodes 105, such as via an iframe (e.g. also called an inline frame), and the threshold public key PUB_th. The login ID, via the iframe which is part of the webpage of the relying party system, allows for encryption computations to be made by both the browser 103 and the trusted node 105.

The operations in blocks 804 and onwards, for example are executed based on the login ID compute data sent by the relying party system to the browser.

At block 804, the browser obtains the subject data (SD) that will be later used by the relying party system to perform the desired subject actions. The subject data is data that is desired to be kept private and stored on the blockchain network of nodes, so that the user or the browser does not need to repeatedly obtain the subject data every time the subject action takes place. In other words, the user or the browser, or both, only obtains the subject data one time. For example, the subject data is PII.

In an example aspect, the SD includes different types of information and the browser organizes the SD into one or more data parcels (block 805). For example, one SD data parcel includes name information; another SD data parcel includes address information; another SD data parcel includes date of birth information; another SD data parcel includes driver's license information; another SD data parcel includes payment card information; etc. In an example aspect, two or more information types can be combined into one data parcel. In another example aspect, each data parcel is tagged to indicate the type of information without identifying the value of the information, as the value of the information is the subject data itself.

At block 806, the browser generates one or more One Time Pads (OTPs).

At block 807, the browser computes one or more obfuscated SD parcels, denoted herein as SD′ or multiple SD's, using the one or more OTPs and the one or more SD data parcels. For example, a given SD′=SD⊕OTP. The xor function is an example process that is computationally efficient. However, other processes for obfuscating SD using OTP are applicable to the principles described herein.

At block 808, the browser encrypts the one or more OTPs to get one or more ciphers C_{OTP}. For example, the encryption is done using the threshold public key PUB_th. This can be expressed as a given C_{OTP}=E_{PUB_th}(OTP).

At block 808, the browser encrypts the one or more SD′ values to get one or more ciphers C_{SD}. For example, the encryption is done using a public key of the trusted node, referred to as PUB_trusted_node. This can be expressed as a given C_{SD}=E_{PUB_trusted_node}(SD′).

In an alternative embodiment, the user enters in SD (block 804) via the browser. The subject data (SD) can be plain text, an image, numbers, etc. The browser sends SD to the trusted node. The trusted node computes 805, 806, 807, 808, 809. Then trusted node then deletes SD.

In an example embodiment, there are n number of SD data parcels (as per block 805), and n number of OTPs are computed (block 806) for each SD data parcel. n is a counting number. Accordingly, n number of SD′ values are computed (block 807) corresponding to each of the n number of SD data parcels. n number of C_{OTP} ciphers (block 808) and n number of C_{SD} ciphers (block 809) are also computed. In other words, for each SD data parcel, the operations in blocks 806 to 809 are executed.

In another example embodiment, there are n number of SD data parcels (as per block 805), and n number of OTPs are computed (block 806). The n number of SD data parcels and the n number of OTPs are used to compute one obfuscated value SD′ in block 807. Therefore, there may be multiple C_{OTP} ciphers corresponding to n OTPs and one C_{SD} cipher corresponding to one SD′ value.

At block 810, the browser sends the one or more ciphers C_{SD} and the one or more ciphers C_{OTP} to the trusted node.

At block 811, the trusted node generates and sends a challenge to the browser. In an example embodiment, the challenge is a function of the one or more ciphers C_{SD} and the one or more ciphers C_{OTP}.

At block 812, responsive to the challenge, the browser performs authentication, and includes obtaining data from the user. This could be user ID data or other data to authenticate the user. User ID data could include a password, biometric data (e.g. fingerprint, eye scan, etc.), a secret code, credentials, etc.

At block 813, the authentication data is sent to the trusted node, which then verifies the authentication data (block 814).

If the authentication data is verified, then the trusted node computes and stores the one or more SD′ values (block 815). In particular, the trusted node decrypts the one more ciphers C_{SD} using the trusted node private key PRIV_trusted_node that corresponds to the public key PUB_trusted_node, which outputs the one or more SD′ values.

At block 816, the one or more ciphers C_{OTP} are sent to the blockchain network of nodes for storage (block 817).

In an example embodiment, the authentication process at block 812 adheres to the FIDO process, which is developed by the FIDO Alliance (www.fidoalliance.com) and World Wide Web Consortium (W3C). FIDO stands for Fast Identity Online. For example, as part of the authentication process, the user touches their finger to a fingerprint scanner on their user device 102, or places their face in front of a camera or another scanner on the user device for facial identification, or looks into one or more cameras on the user device for eye identification. Other types of authentication can also be used. In an example embodiment, the challenge at block 811 is a FIDO challenge and is computed by hashing (random ∥C_{SD}∥C_{OTP}). In the blocks 815, 816 and 817, a FIDO public key is also transmitted amongst the entities and stored on both the trusted node and on the blockchain network of nodes. The corresponding FIDO private key is securely stored on the user device, for example, in a secure element 112 of the user device.

After the ciphers of the OTPs are stored in an encrypted form on the blockchain, the retrieval and decryption process can occur repeatedly at different later times. In other words, the user does not need to re-enter the SD in order for the relying party system to execute some action that uses the SD. The relying party system is able to retrieve the SD′ and decrypt it to get SD and perform one or more subject actions that uses the SD.

In an example aspect, the OTP at blocks 805 and 806 is a cryptographic key. In this way, the data stored on a (permission) blockchain is not some variant of SD, but a cryptographic key that is independent of SD.

By separating the different types of information into data parcels at block 805, each data parcel can stored separately and retrieved separately at a later time (e.g. for different reasons, by different relying party systems, etc.). For example, in this example storage operation, a person 101 provides their name (e.g. a first data parcel), their address (e.g. a second data parcel), and their date of birth (e.g. a third data parcel). By separating this subject data into data parcels at this time, at a later time, the person 101 may only allow their name (e.g. the first data parcel) to be accessed and provided as part of a different action, or to interact with a different relying party system, or both.

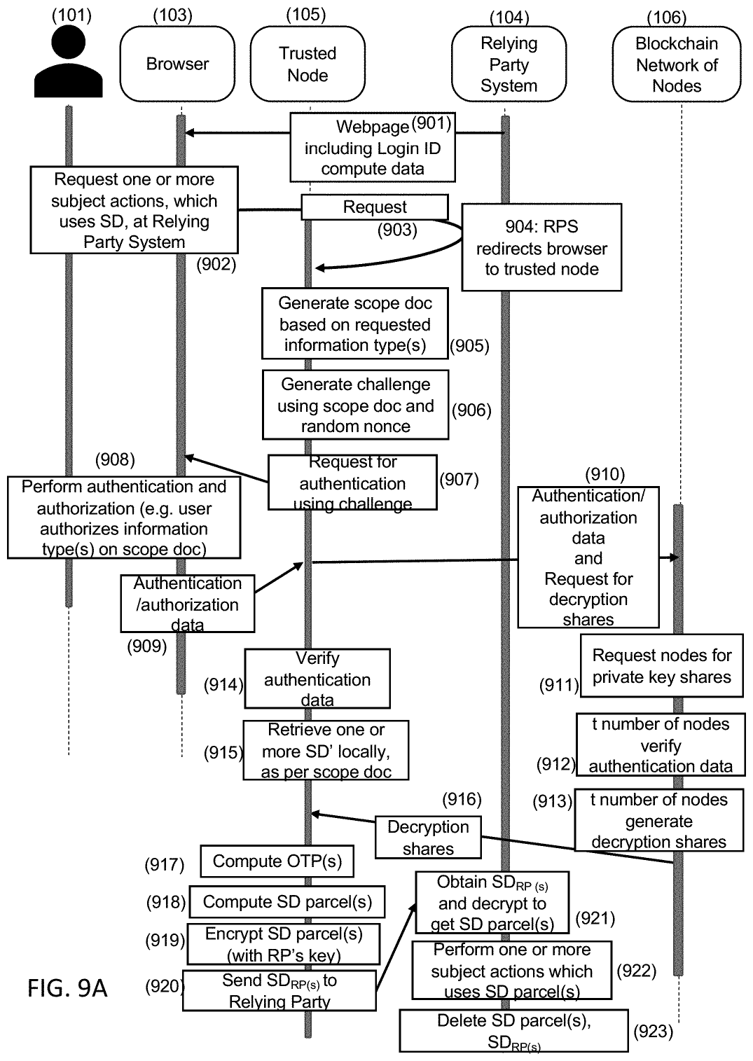

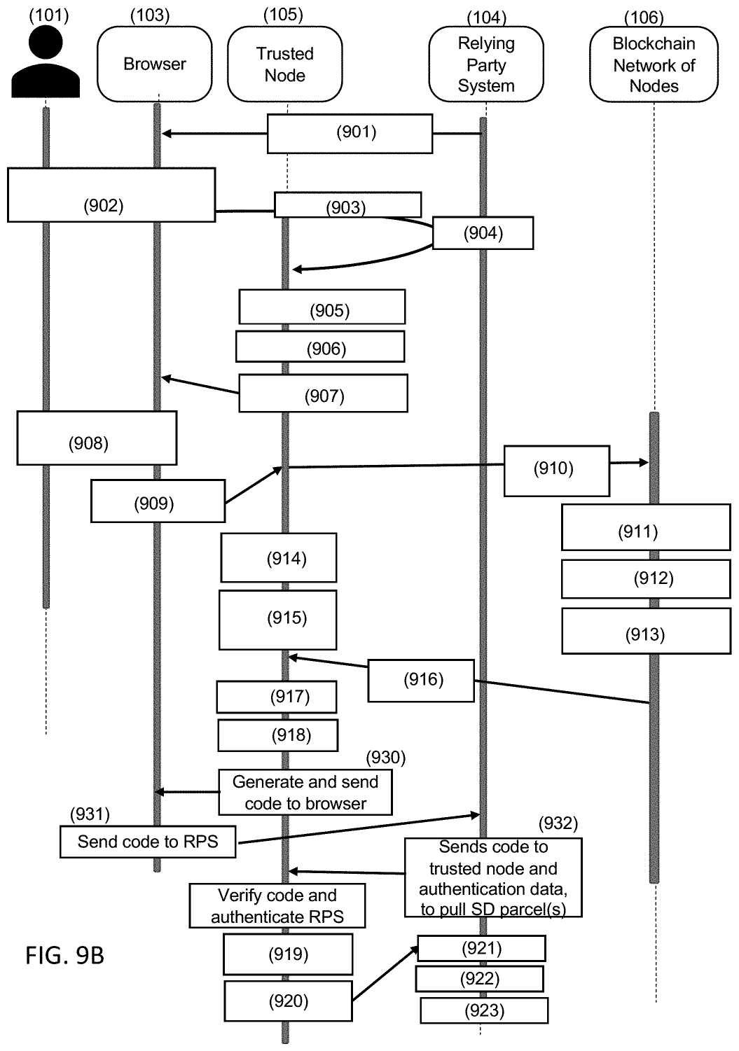

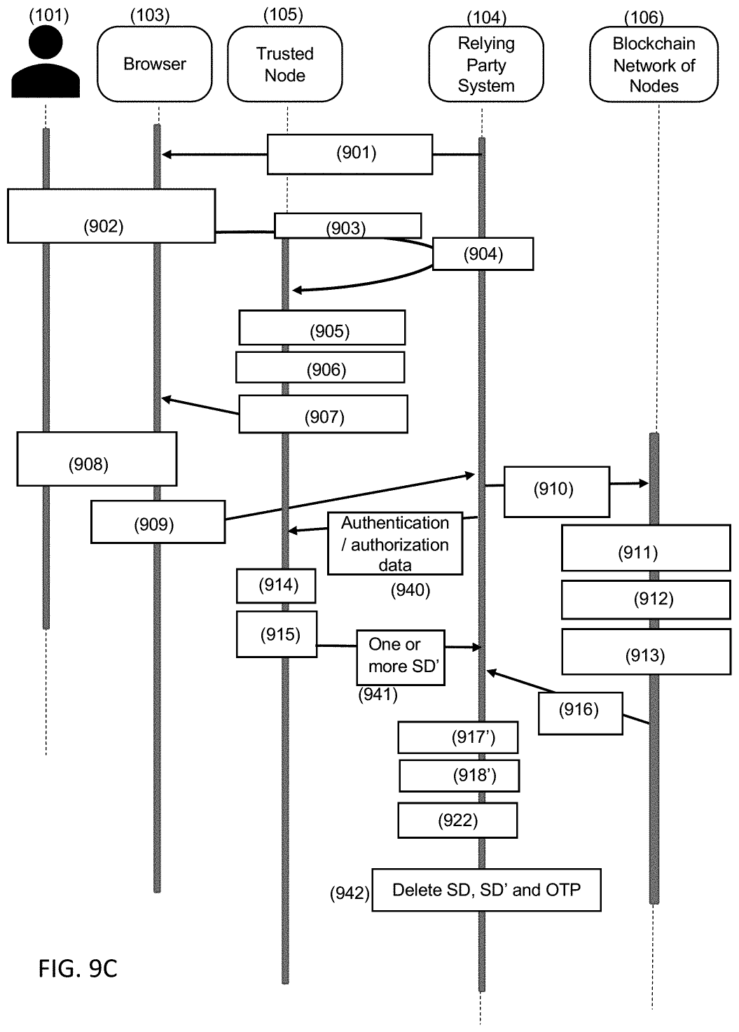

Turning to FIG. 9A, the decryption process is shown according to an example embodiment.

At block 901, the relying party system sends the webpage to the browser, including the login ID compute data. For example, this login ID compute data includes Java Script code.

At block 902, the browser generates a request for one or more subject actions, which uses one or more SD data parcels. This request is sent to the relying party system at block 903. At block 904, the relying party system redirects the browser to the trusted node 105, including sending the request to the trusted node.

At block 905, the trusted node 105 generates a scope document based on the requested information types stored in the one or more SD data parcels. For example, if the subject action includes the person's name and address, then the scope document includes this information. It will be appreciated that the scope document is a data file that identifies the scope of the information being requested by the relying party system 104. In another example aspect, the scope document also identifies the identity of the relying party system that has made the request. In another example embodiment, the scope document identifies the scope of usage of the information being requested.

In an example aspect, the type of content of the subject data is shown in the scope document, but not the actual data itself. This is for security to reduce the transfer of private data to the user device. For example, the subject data parcels include a user's name that is Joe Smith; his address that is 123 Main Street, Cleveland, Ohio, USA; and, has a photo from his driver's license. The scope document specifies name, address, and photograph from driver license. It does not specify the contents itself. The contents of the subject data parcels are stored using the trusted node and the blockchain network of nodes.

It will also be appreciated that different actions requesting different types of information will result in different scope documents. For example, in one request for data, a user's name and address are requested, resulting in a scope document that identifies a user name data type and an address data type. In another request for data, the user's name, age, driver license number, and photograph are requested, resulting a different scope document that identifies user name data type, age data type, driver license number data type, and photograph data type.

At block 906, the trusted node generates a challenge using the scope document and a random nonce. In other words, the challenge is a function of the scope document and the random nonce.

At block 907, the trusted node generates and sends a request for authentication to the browser 103. The request for authentication includes the challenge.

At block 908, the browser (e.g. with the user 101) performs the authentication of the user and authorization of the requested data in the scope document. For example, browser displays via a GUI to the user the specific types of information to be provided to the relying party system, as specified in the scope document. If the user agrees with the types of information to be provided, then the user provides authorization and authentication of themselves. This process, for example, could be done in one user action or several user actions. For example, the authentication and authorization use biometrics. In another example embodiment, the biometrics are used as part of the FIDO authentication process. For example, the user provides their fingerprint to a fingerprint or thumbprint scanner on the user device. In another example, the user positions a facial scanner (e.g. camera system or LiDAR system, or both) in front of their face to obtain a facial scan. Other types of biometric scanning can be used to provide authentication and authorization in the FIDO process.

In an example aspect, using the GUI, the user can select which specific types of information can be provided to the relying party system, and which other specific types are not permitted to be provided to the relying party system. For example, the request for data includes the user's name, age, driver license number, and photograph. However, the user only provides confirmation, via the GUI, for the relying party to obtain the user's name and age.

At block 909, the browser sends the authentication and the authorization data to the trusted node. The authentication and the authorization data include the scope document, the nonce and the user's signature. In other words, the authentication and the authorization data is in the form of a signed challenge response. In an example aspect, the FIDO authentication uses a FIDO private key that is used by the user device to sign a challenge response. In another example aspect, the signed challenge response includes the scope document.

In the example embodiment where only a subset of the information types have been permitted to be obtained by the relying party, this subset is identified in the scope document in the signed challenge response. In a further example aspect, the other subset of information types that have denied permission to be obtained by relying party are indicated in the scope document that forms party of the signed challenge response.

It will be appreciated that this process that includes the scope document allows the user to control the types of data being obtained by the relying party system. It also creates a record that, if needed, shows to parties the user data being requested by the relying party system and that the user himself or herself provided the authorization. Conversely, if specific data types are denied permission to the relying party system, this denial from the user can be recorded in the signed challenge response.

At block 914, the trusted node verifies the authentication data. If the authentication data has been verified, then the trusted node retrieves the one or more SD′ values from local memory storage (block 915).

In a preferred example embodiment, blocks 910 to 913 are executed after block 914. In another example embodiment, blocks 910 to 913 occur in parallel or before block 914.

In blocks 910 to 913, the trusted node sends the authorization data or authentication data, or both, and sends a request for decryption shares to the blockchain network of nodes (block 916).

At block 910, the trusted node provides the authorization data or authentication data, or both, and a request to the block chain network of nodes to obtain the private key shares (also called decryption shares). In particular, the trusted node identifies the one or more obfuscated subject data parcels that correspond to the data or information types specified in the scope document. The trusted node then identifies the private key shares that correspond to these one or more obfuscated subject data parcels. The trusted node then generates and sends the request to the blockchain network for these identified private key shares.

Following block 910, the blockchain network of nodes then request the relevant nodes for private key shares (block 911). For example, the request is attempted to be sent to the N nodes that respectively possess the private key shares PRIV_th_{1 . . . N}.

At block 912, at least t number of nodes verify the authorization data or authentication data, or both, from the trusted node. In an example aspect, the authorization data or authentication data, or both, is a digital signature from the trusted node that has been signed using a private key of the trusted node. The blockchain network of nodes have the corresponding public key to executing the verification computation. Other computations for verifying the request from the trusted node can be used in alternative or in combination.

If the t number of nodes each verify the authorization data or authentication data, then at block 913 the t number of nodes generate decryption shares using the private key shares and the cipher C_{OTP}.

In an example aspect, each blockchain network node i in the Reconstruction Set R will verify the authorization data or authentication data, or both. It is appreciated that |R|=t≤N. After verification, each node i generates a decryption share DSᵢ, where DSᵢ, is a function of C_{OTP} and the private key share PRIV_thᵢ.

At block 916, each node i in the Reconstruction Set R sends their respective decryption share DSᵢ to the trusted node. In an example aspect, each decryption share is encrypted using the trusted node's public key (e.g. PUB_trusted_node).

After the trusted node receives the decryption shares from the different block chain nodes, it decrypts this data using the corresponding trusted node's private key (e.g. PRIV_trusted_node).

At block 917, the trusted node computes the one or more OTPs using all the decryption key shares. For example, the relying party system combines the different instances of DSᵢ to compute the one or more OTPs.

At block 918, the trusted node computes the one or more SD data parcels. For example, a given SD data parcel=SD′⊕OTP. The xor function is an example. Another function that is able to retrieve SD from SD′, where SD′ was previously obtained by obfuscating SD using OTP, is applicable to the principles described herein.

At block 919, the trusted node encrypts the one or more SD data parcels, for example using the relying party's public key, thereby forming the encrypted value SD_{RP}.

At block 920, the trusted node sends SD_{RP} to the relying party.

At block 921, the relying party obtains SD_{RP} and decrypts the same using its private key, to get the one more SD data parcels.

At block 922, the relying party system performs one or more subject actions using the SD.

At block 923, after using the one or more SD data parcels, the relying party system deletes the one or more SD data parcels and SD_{RP}.

In an example embodiment, the one or more ciphers C_{OTP} are retrieved by using an identifier from the authentication data. In other words, when the given C_{OTP} was initially stored during the encryption process on the blockchain, it was stored in association with an identifier from the authentication data. In a further example aspect where the authentication process adheres to the FIDO Alliance, the identifier is a FIDO public key. It will be appreciated that there are other ways to retrieve the one or more ciphers C_{OTP} from the blockchain network of nodes.

In other example embodiments, after the subject data SD has been obfuscated and stored on the decentralized computing system (e.g. the trusted node), which is part of the encryption process described in FIG. 8, it may be desirable to delete the obfuscated data SD′. The deletion process can occur after a decryption process (e.g. as described in FIG. 9A).

Using the process in FIG. 9A, the user reviews and verifies their specific types of subject data before allowing the relying party system to access the data. Furthermore, the scope document is part of the decryption process, which ensures that other data (e.g. that is not specified in the scope document) cannot be accessed and decrypted.

At block 908, if the user does not want to provide the requested subject data to the relying party, the user inputs a denial response into the GUI and the session between the relying party system and the trusted node to obtain the requested data becomes terminated. The subject data requested by the relying party system is not transmitted nor accessible to the relying party system.

In another example embodiment similar to FIG. 9A, in FIG. 9B, after block 918, the trusted node generates and sends a code to a browser. The code identifies the user and the session to obtain the requested data of the user. At block 931, the browser sends the code to the relying party system. At block 932, the relying party system sends the code back to the trusted node and undergoes an authentication process with the trusted node. In this way, the relying party system initiates a pull operations for the SD data parcels from the trusted node. At block

FIG. 9B is similar to FIG. 9A, but the SD is computed by the relying party system instead of the trusted node. Following block 905, the authentication data is sent from the browser to the relying party system (block 906′). The relying party sends the authentication data and a request for decryption shares to the blockchain network of nodes (block 909′). The relying party system also sends the authentication data and a request for SD′ from the trusted node. The authentication process can include one or more of a signature, a secret password, HMAC, encryption, etc. This pull operation initiated by the relying party system provides more control to the relying party system in how data is obtained by the relying party system. At block 920, the trusted node receives the code and authenticates the relying party system. The operations 919 to 923 are then executed.

In another example embodiment, in FIG. 9C, which is an alternative to FIG. 9A, the computations of the one or more OTPs and the computations of the one or more SD data parcels takes place on the relying party system instead of on the trusted node. In particular, in FIG. 9C, the authorization and authentication data is set by the browser to the relying party system, and this data is also sent by the relying party system to the trusted node (block 940). After block 915, the one or more SD′ values are sent to the relying party system. The decryption shares from the blockchain network of nodes is also sent to the relying party system (block 916).

At block 917′, the relying party system computes the one or more OTPs using all the decryption key shares. For example, the relying party system combines the different instances of DSᵢ.

At block 918′, the relying party system computes the one or more SD data parcels. For example, a given SD data parcel=SD′⊕OTP. The xor function is an example. Another function that is able to retrieve SD from SD′, where SD′ was previously obtained by obfuscating SD using OTP, is applicable to the principles described herein.

Block 922 is executed. At block 942, relying party system deletes from its memory stores the one or more SD data parcels, the one or more SD′ values, and the one or more OTPs.

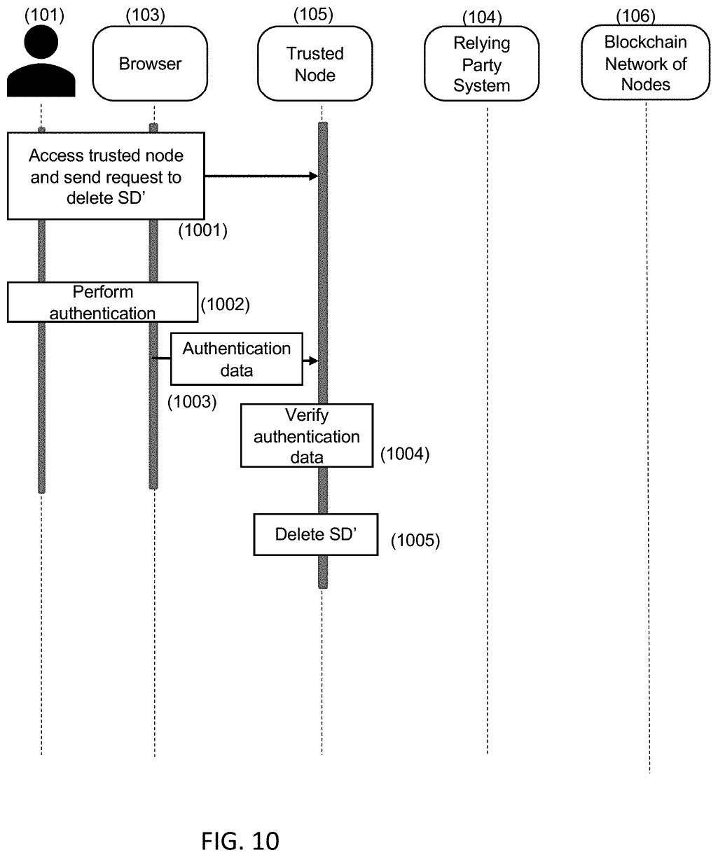

The example embodiments in FIGS. 10 to 12 show different computations for deleting the subject data from the decentralized computing system, including the trusted node 105. For example, this can be used by a user to execute their right to be forgotten should the subject data include personal identifiable information, or the like.

In FIG. 10, the browser 103 (e.g. with the initiation of the user 101) accesses the trusted node and sends a request to delete SD′ (block 1001). At block 1002, the browser also perform authentication. At block 1003, authentication data is sent from the browser to the trusted node. The trusted node verifies the authentication data (block 1004) and then deletes SD′ (block 1005).

By deleting SD′, other parties (e.g. adversary entities) cannot reproduce SD even from the other data stored on the blockchain network of nodes.

In an example aspect, the trusted node requests that the blockchain network of nodes deletes C_{OTP} from the blockchain. However, as many blockchains implement an immutable ledger, the deletion of C_{OTP} would be recorded. In some cases, it is desirable to record the deletion of C_{OTP}. In other cases, it is undesirable to delete C_{OTP}, as this could notify the blockchain network that SD′ has been deleted, which could potentially be used in an adversarial way. Therefore, there are embodiments in which C_{OTP} is deleted from the blockchain, and there are embodiments where C_{OTP} is not deleted from the blockchain.

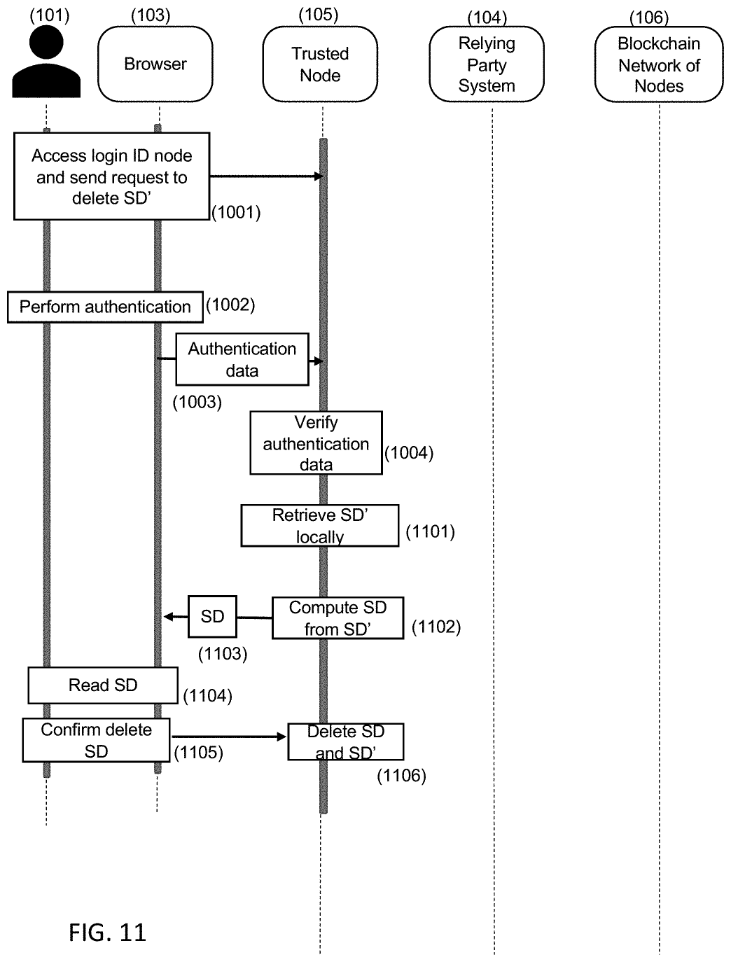

FIG. 11 is similar to FIG. 10 and includes the blocks 1001 to 10004. After block 1004, the trusted node retrieves SD′ locally from memory (block 1101).

At block 1102, the trusted node computes SD from SD′. This is done by the trusted node requesting decryption shares from the blockchain network of nodes, which then in response executes blocks 910, 911, 912. The decryption shares are provided to the trusted node, and the trusted node uses this information to compute OTP (similar to block 916 but on the trusted node) and then to compute the SD.

At block 1103, the trusted node sends the SD to the browser.

At block 1104, the browser and the user read the SD, and the browser sends a confirmation to delete the SD (block 1105). At block 1106, the trusted node deletes SD and SD′. In other words, the user can first read the subject data SD before confirming its deletion.

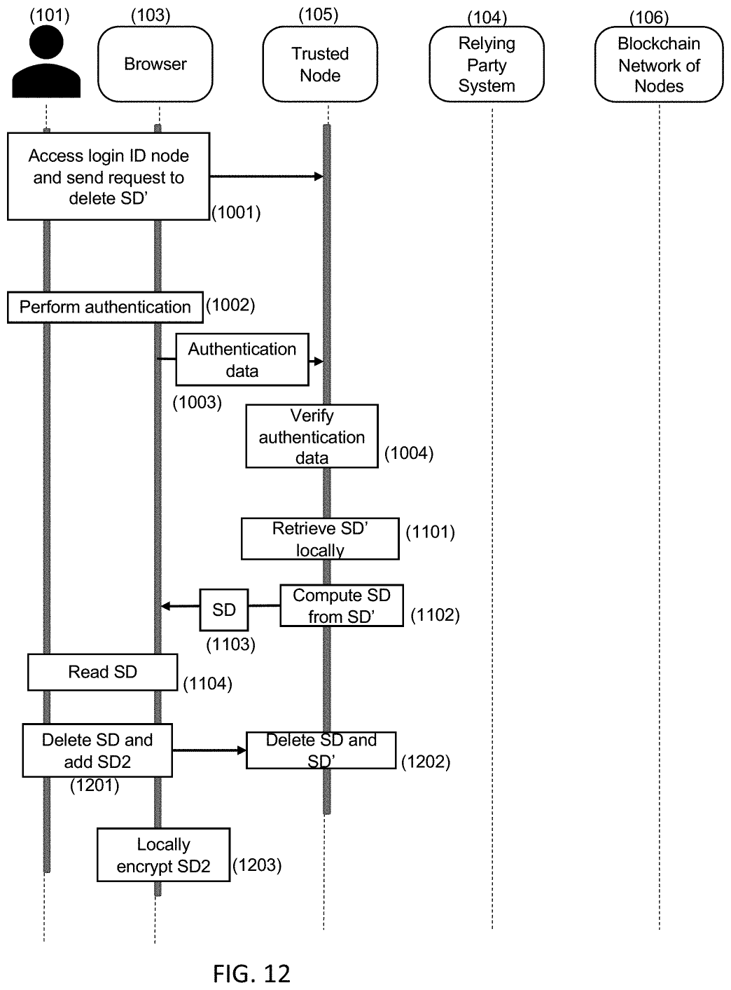

FIG. 12 shows a similar embodiment to FIG. 11, including the operations up to block 1104.

After block 1104, the browser deletes SD and adds new subject data SD2 (block 1201). This operation of deleting the initial SD and the adding new subject data SD2 is like a modification operation. This then causes the trusted node to delete SD and SD′ (block 1202).

The new subject data SD2 is then locally encrypted (block 1203). In particular, the process is similar to the encryption process described in FIG. 8 for obfuscating SD, but now SD2 is obfuscated to output SD2′.

It will be appreciated that, using the above computations, the user deletes SD′ which then makes the subject data SD safe. In other words, an adversary cannot recoup SD. The remaining shards of information on the blockchain cannot be used to recover SD. Furthermore, the shards of information on the blockchain becomes irrecoverable. This guarantees that the login system provided herein provides compliance with privacy regulations such as GDPR (e.g. the right to be forgotten).

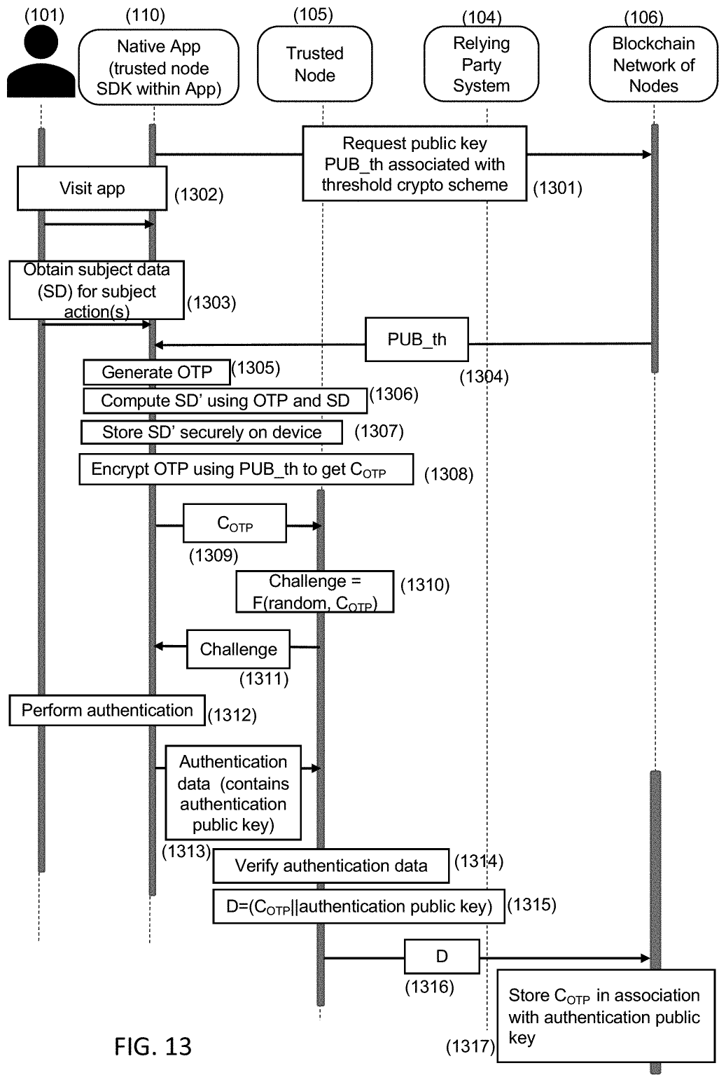

In another example embodiment, the subject data SD, or SD data parcels, are encrypted using a native application 110 that resides on the user device 102, instead of a browser. For example, a merchant or a company has a native application 110 (also herein called an app) that includes the trusted node's software developer kit. Turning to FIG. 13, the app 110 sends a request to the blockchain network of nodes for the public key PUB_th associated with the threshold crypto scheme (block 1301).

Although SD is used in this example, it will be appreciated that these principles in FIG. 13 apply to SD data parcels, similar to the process described in FIG. 8. In other words, multiple ciphers C_{OTP} can be stored on the blockchain network in FIG. 13.

Continuing with FIG. 13, it will be appreciated that the blockchain network of nodes generates a distributed key generation (DKG) key set where PUB_th is a public key and the corresponding private key shares are {PRIV_th_{1 . . . N}}. N is the number of private key shares that are outputted, where each private key share is respectively generated and stored on a different node or a different computing device on the blockchain network. In other words, there are multiple private key shares that correspond to one public key. A threshold number t is also provided, where t≤N. In this way, it is possible that a smaller number of private keys shares (e.g. smaller than the total number N created) are required to execute a decryption.

At block 1302, the user visits the app 110 (e.g. by selecting the app on their user device).

At block 1303, the app 110 obtains the subject data SD for one or more subject actions. For example, the user inputs SD.

At block 1304, the app obtains PUB_th.

At block 1305, the app generates an OTP. For example, the OTP is a random value.

At block 1306, the app computes SD′ using the OTP and SD. For example, SD′=SD⊕OTP.

At block 1307, the app securely stores SD′ on the user device 102.

At block 1308, the app encrypts the OTP using the PUB_th, to output C_{OTP}. For example, C_{OTP}=E_{PUB_Threshold}(OTP)

At block 1309, the app sends C_{OTP} to the trusted node.

At block 1310, the trusted node computes a challenge that is a function of a random value and C_{OTP}. For example, challenge=F(random, C_{OTP}).

At block 1311, the challenge is transmitted from the trusted node to the app.

At block 1312, the app performs an authentication process with the user. For example, the authentication process includes obtaining user data from the user. For example, the user data is biometric data from the user. In another example embodiment, the authentication process is a FIDO authentication process that uses biometric data, such as a fingerprint scan. For example, the user touches a fingerprint scanner on their user device to perform authentication.

At block 1313, the authentication data is sent from the app to the trusted node. For example, the authentication data includes the authentication public key. An example of the authentication public key is the FIDO public key, where the FIDO authentication process is used.

At block 1314, the trusted node verifies the authentication data.

At block 1315, the trusted node computes D=(C_{OTP}∥authentication public key). In the example of using the FIDO authentication process, then D =(C_{OTP}∥FIDO public key).

At block 1316, the value D is transmitted to the blockchain network of nodes.

At block 1317, the blockchain network of nodes stores C_{OTP} in association with the authentication public key.

To request the SD, the app 110 makes a request for the decryption key shares. The app sends authentication data to the blockchain network of nodes, and the blockchain network of nodes verify the authentication data. For example, in a FIDO authentication process, the blockchain network of nodes verify the FIDO authorization signature. After verification, the blockchain network of nodes then send the decryption key shares to the trusted node. The decryption key shares are then used by the trusted node to rebuild the OTP. In other words, principles in FIGS. 9A, 9B and 9C can be generally applied to the native application.

Below are general example embodiments and example aspects.

In an example embodiment, a computing system designated as a trusted node is provided. The computing system comprises:
a communication system configured to communicate with a user device, a relying party system and a blockchain network of nodes;
a memory that stores at least one or more obfuscated subject data (SD′) parcels; and
a processor system that executes executable instructions comprising: computing a challenge using a scope document specifying one or more types of information in one or more subject data (SD) parcels, wherein the challenge is a function of the scope document and a random nonce; transmitting the challenge to the user device to initiate an authentication process; receiving a signed challenge response from the user device; verifying the signed challenge response, which comprises verifying the signed challenge response comprises the scope document; and, if the signed challenge response is verified, computing one or more One Time Pads (OTPs) using multiple decryption shares obtained from the blockchain network of nodes, wherein the one or more OTPs correspond to the one or more obfuscated SD′ parcels; using the one or more OTPs and the one or more obfuscated SD′ parcels to compute the one or more SD parcels; and transmitting the one or more SD parcels to at least one of the user device and the relying party system.

In an example aspect of the computing system, the signed challenge response comprises the scope document, the nonce and a digital signature signed by a private key stored on the user device, and a corresponding public key is stored on the memory of the computing system that is used to verify the digital signature.

In another example aspect of the computing system, the signed challenge response comprises the scope document, the nonce and a digital signature signed by a Fast Identity Online (FIDO) private key stored on the user device, and a corresponding FIDO public key is stored on the memory of the computing system that is used to verify the digital signature.

In another example aspect of the computing system, the scope document further comprises identity data of the relying party system that is requesting the one or more subject data parcels.

In another example aspect of the computing system, the scope document comprises usage data of the subject data parcels.

In another example aspect of the computing system, the processor previously computed the one or more obfuscated SD′ parcels using the one or more OTPs and the one or more SD parcels.

In another example aspect of the computing system, a given SD parcel computed from a given OTP and a given obfuscated SD′ parcel comprises the given SD parcel=the given obfuscated SD′ parcel ⊕ the given OTP.

In another example aspect of the computing system, the memory further stores a public key of the relying party system, and the one or more SD parcels are transmitted in encrypted form; and the executable instructions further comprise: encrypting the one or more SD parcels using the public key of the relying party system to output SDRP; and transmitting SDRP to the relying party system.

In another example aspect of the computing system, each one of the multiple decryption key shares is initially encrypted using a public key of the trusted node, and the computing system decrypts each one of the decryption key shares using a private key of the trusted node, which corresponds to the public key of the trusted node.

In another example aspect of the computing system, the processor combines the decryption keys shares to compute the OTP.

In another example aspect of the computing system, the one or more types of information specified in the scope document are displayable via a graphical user interface on the user device.

In another example aspect of the computing system, the signed challenge response, which comprises the scope document, is used to create a record of the user device providing authorization to the relying party system to obtain the one or more types of information specified in the scope document.

In another example aspect of the computing system, different ones of the one or more SD parcels correspond to different types of information.

In another example aspect of the computing system, at least one of the SD parcels comprises a user name and another one of the SD parcels comprises an address.

In another example aspect of the computing system, at least one of the SD parcels comprises a user name and another one of the SD parcels comprises a photograph.

In another example embodiment, a user device is provided and it comprises: a communication system configured to communicate with a trusted node and a relying party system;
a display device;
a memory that stores at least a user agent, comprising at least one of a browser and a native application;
a secure element that stores at least a private key;
a biometric scanning device; and
a processor system that executes executable instructions comprising: receiving a challenge from the trusted node, wherein the challenge comprises a scope document specifying one or more types of information in one or more subject data (SD) parcels, which are requested to be obtained by the relying party system; displaying the one or more types of information via the user agent in a graphical user interface on the display device; receiving a confirmation user input to provide the one or more types of information; after using the biometric scanning device to authenticate a user of the user device, using the private key to digitally sign a challenge response, wherein the challenge response comprises the scope document.

In an example aspect of the user device, the challenge is a function of the scope document and a random nonce; and wherein the signed challenge response is a function of the scope document and the random nonce.

In another example aspect of the user device, the private key is a Fast Identity Online (FIDO) private key stored on the secure element, and a corresponding FIDO public key is obtainable by the trusted node.

In another example aspect of the user device, the scope document further comprises identity data of the relying party system that is requesting the one or more subject data parcels.

In another example aspect of the user device, the user agent communicates initially with the relying party system to complete an action that uses the one or more SD parcels, which initiates the user device receiving the challenge from the trusted node.

In an example embodiment, a computing system designated as a trusted node, includes a communication system that is in communication with a user device, a relying party system and a blockhain network of nodes. The computing system that is the trusted node also includes a memory that stores at least a threshold public key that corresponds to multiple private key shares, wherein the trusted node receives the threshold public key from the blockhain network of nodes. The computing system that is the trusted node also includes a processor system that executes at least: computing a challenge using a cipher C_{SD} of a subject data (SD) and a cipher C_{OTP} of a One Time Pad (OTP) from the user device; transmitting the challenge to the user device to initiate an authentication process; after receiving authentication data from the user device, verifying the authentication data; and, if the authentication data is verified, decrypting the cipher C_{SD} using the trusted node's private key to output and locally store SD′ in the memory, and transmitting the cipher C_{OTP} to the blockchain network of nodes.

In an example aspect, the challenge is a FIDO challenge that is computed by hashing (a random value∥the cipher C_{SD}∥the cipher C_{OTP}).

In another example aspect, the memory further stores a FIDO public key.

In another example aspect, the OTP is a cryptographic key.

In another example aspect, after receiving and verifying a later instance of authentication data, the processor system at least further executes: retrieving the SD′ from the memory; obtaining decryption key shares that corresponds to some or all of the multiple private key shares from the blockchain network of nodes; computing the OTP using the decryption key shares; computing the SD from the OTP and SD′; encrypting the SD with the relying party system's public key to output SD_{RP}; and initiating transmitting SD_{RP} to the relying party system.

In another example aspect, there are N private key shares that comprise the multiple private key shares, and t number of decryption key shares are each one generated as function of a corresponding one of t private key shares and the cipher C_{OTP}, wherein t≤N.

In another example aspect, each one of the decryption key shares is initially encrypted using a public key of the trusted node, and the computing system decrypts each one of the decryption key shares using a private key of the trusted node, which corresponds to the public key of the trusted node.

In another example aspect, the processor combines the decryption keys shares to compute the OTP.

In another example aspect, computing the SD from the OTP and the SD′ comprises SD=SD′⊕OTP.

In another example embodiment, a method for encrypting and later deleting subject data from a decentralized computing system is provided. The method includes an encryption process, and encryption process includes: a web browser on a user device obtaining the subject data; the web browser computing a One Time Pad (OTP), an obfuscation SD′ of the subject data, a cipher C_{OTP} of the OTP using a threshold public key, and a cipher C_{SD} of the SD′ using a public key of a trusted node; the web browser sending the C_{SD} and the C_{OTP} to the trusted node, wherein the trusted node stores a private key corresponding to the public key of the trusted node for decrypting C_{SD} to get the SD′; and wherein the trusted node is in communication with a blockchain network that stores multiple private keys shares corresponding to the threshold public key. The method also includes a deletion process, and the deletion process includes: the web browser sending a delete command to the trusted node to delete the C_{SD} and SD′.

In another example embodiment, a method is provided for a computing system to perform one or more subject actions using subject data. The method includes an encryption process and a decryption process. The encryption process includes: the computing system receiving a threshold public key that has been computed by a blockchain network, and where multiple private key shares correspond to the threshold public key, and the multiple private key shares are respectively distributed across multiple nodes that form part of the blockchain network. The encryption process also includes: the computing system transmitting a webpage with login compute data to a web browser, the login compute data comprising the threshold public key and executable instructions for the browser to execute to generate a cipher C_{OTP} of a One Time Pad (OTP) and a cipher C_{SD} of the subject data, and for the browser to initiate storage of C_{SD} on a trusted node and initiate storage of the C_{OTP} on the blockchain network.

In an example aspect, the decryption process includes: the computing system receiving a request from the browser to request the one or more subject actions, which uses the subject data; the computing system obtaining an obfuscation of the subject data from the trusted node, wherein the obfuscation of the subject data is a function of the subject data and the OTP; the computing system obtaining multiple decryption shares from the multiple nodes that respectively store the multiple private key shares; the computing system computing the OTP from the multiple decryption shares; the computing system computing the subject data, which is a function of the obfuscation of the subject data and the OTP; and, the computing system using the subject data to execute the one or more subject actions.

In an example aspect, the method further includes the computing system deleting the subject data, the obfuscation of the subject data and the OTP from local memory of the computing system.

In another example aspect, the decryption process further includes the computing system receiving authentication data from the browser, and the computing system sends the authentication data to the trusted node to obtain obfuscation of the subject data.

In another example aspect, the decryption process further includes the computing system receiving authentication data from the browser, and the computing system sends the authentication data to the multiple nodes in the blockchain network to obtain the multiple decryption shares.

In another example aspect, each one of the multiple decryption shares is a function of the C_{OTP} and a given one of the multiple private key shares residing on a given one of the multiple nodes.

In another example aspect, the computing system receives at least a threshold number t of decryption key shares, where t≤N, and wherein N is the number of the multiple private key shares that correspond to the threshold public key.

In another example aspect, the computing system computes: the subject data=the obfuscation of the subject data⊕OTP.

In another example aspect, in the decryption process, the computing system receives an encrypted form of the multiple decryption shares, and the computing system decrypts the encrypted form using a public key associated with the computing system.

In another example aspect, the OTP is a cryptographic key.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, EEPROM, flash memory or other memory technology, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers or computing devices or nodes, or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. A computing system designated as a trusted node, comprising:
a communication system configured to communicate with a user device, a relying party system and a blockchain network of nodes;
a memory that stores at least one or more obfuscated subject data (SD′) parcels; and
a processor system that executes executable instructions comprising: computing a challenge using a scope document specifying one or more types of information in one or more subject data (SD) parcels, wherein the challenge is a function of the scope document and a random nonce; transmitting the challenge to the user device to initiate an authentication process; receiving a signed challenge response from the user device; verifying the signed challenge response, which comprises verifying the signed challenge response comprises the scope document; and, if the signed challenge response is verified, computing one or more One Time Pads (OTPs) using multiple decryption shares obtained from the blockchain network of nodes, wherein the one or more OTPs correspond to the one or more obfuscated SD′ parcels; using the one or more OTPs and the one or more obfuscated SD′ parcels to compute the one or more SD parcels; and transmitting the one or more SD parcels to at least one of the user device and the relying party system.

2. The computing system of claim 1 wherein the signed challenge response comprises the scope document, the nonce and a digital signature signed by a private key stored on the user device, and a corresponding public key is stored on the memory of the computing system that is used to verify the digital signature.

3. The computing system of claim 1 wherein the signed challenge response comprises the scope document, the nonce and a digital signature signed by a Fast Identity Online (FIDO) private key stored on the user device, and a corresponding FIDO public key is stored on the memory of the computing system that is used to verify the digital signature.

4. The computing system of claim 1 wherein the scope document further comprises identity data of the relying party system that is requesting the one or more subject data parcels.

5. The computing system of claim 1 wherein the scope document comprises usage data of the subject data parcels.

6. The computing system of claim 1 wherein the processor previously computed the one or more obfuscated SD′ parcels using the one or more OTPs and the one or more SD parcels.

7. The computing system of claim 1 wherein a given SD parcel computed from a given OTP and a given obfuscated SD′ parcel comprises the given SD parcel=the given obfuscated SD′ parcel⊕the given OTP.

8. The computing system of claim 1 wherein the memory further stores a public key of the relying party system, and the one or more SD parcels are transmitted in encrypted form; and the executable instructions further comprise: encrypting the one or more SD parcels using the public key of the relying party system to output SD_{RP}; and transmitting SD_{RP} to the relying party system.

9. The computing system of claim 1 wherein each one of the multiple decryption key shares is initially encrypted using a public key of the trusted node, and the computing system decrypts each one of the decryption key shares using a private key of the trusted node, which corresponds to the public key of the trusted node.

10. The computing system of claim 1 wherein processor combines the decryption keys shares to compute the OTP.

11. The computing system of claim 1 wherein the one or more types of information specified in the scope document are displayable via a graphical user interface on the user device.

12. The computing system of claim 1 wherein the signed challenge response, which comprises the scope document, is used to create a record of the user device providing authorization to the relying party system to obtain the one or more types of information specified in the scope document.

13. The computing system of claim 1 wherein different ones of the one or more SD parcels correspond to different types of information.

14. The computing system of claim 13 wherein at least one of the SD parcels comprises a user name and another one of the SD parcels comprises an address.

15. The computing system of claim 13 wherein at least one of the SD parcels comprises a user name and another one of the SD parcels comprises a photograph.

16. A user device, comprising:
a communication system configured to communicate with a trusted node and a relying party system;
a display device;
a memory that stores at least a user agent, comprising at least one of a browser and a native application;
a secure element that stores at least a private key;
a biometric scanning device; and
a processor system that executes executable instructions comprising: receiving a challenge from the trusted node, wherein the challenge comprises a scope document specifying one or more types of information in one or more subject data (SD) parcels, which are requested to be obtained by the relying party system; displaying the one or more types of information via the user agent in a graphical user interface on the display device; receiving a confirmation user input to provide the one or more types of information; after using the biometric scanning device to authenticate a user of the user device, using the private key to digitally sign a challenge response, wherein the challenge response comprises the scope document.

17. The user device of claim 16 wherein the challenge is a function of the scope document and a random nonce; and wherein the signed challenge response is a function of the scope document and the random nonce.

18. The user device of claim 16 wherein the private key is a Fast Identity Online (FIDO) private key stored on the secure element, and a corresponding FIDO public key is obtainable by the trusted node.

19. The user device of claim 1 wherein the scope document further comprises identity data of the relying party system that is requesting the one or more subject data parcels.

20. The user device of claim 1 wherein the user agent communicates initially with the relying party system to complete an action that uses the one or more SD parcels, which initiates the user device receiving the challenge from the trusted node.
